(19) United States
(12) Patent Application Publication
(10) Pub. No.: US 2014/0280881 A1
(43) Pub. Date: Sep. 18, 2014

(54) USING LATENCY AND ROUTE INFORMATION TO ESTIMATE LOCATION

(71) Applicant: Google Inc., Mountain View, CA (US)

(72) Inventors: Zoltan Szamonek, Zurich (CH); Luuk van Dijk, Zurich (CH); Hartmut Maennel, Zurich (CH)

(73) Assignee: Google Inc., Mountain View, CA (US)

(21) Appl. No.: 13/831,507

(22) Filed: Mar. 14, 2013

(51) Int. Cl. H04L 12/26

(52) U.S. Cl. CPC H04L 43/08
USPC 709/224

(57) ABSTRACT

Methods, systems, and apparatus, including computer programs encoded on computer storage media, for determining geographical locations of devices. One of the methods includes obtaining a first network address of a first device; obtaining first route information associated with at least one data transmission between the first source network address and a first network address; obtaining a second network address associated with a second device; obtaining second route information associated with at least one data transmission between a second source network address and the second network address; obtaining an estimate for geographical location of the second device; determining a first latency distance between the first network address and the second network address based on the first and second route information; and estimating a geographical location of the first device based on the estimate for geographical location of the second device and the first latency distance.

### BACKGROUND

This specification relates to determining geographical locations of devices on a network, and in particular, user devices.

Knowing the geographical location of a device coupled to a network, e.g., the Internet, can be valuable to systems that provide services to the device or to a user of the device. In many situations, a device's location cannot be easily determined.

### SUMMARY

In general, one innovative aspect of the subject matter described in this specification can be embodied in methods that include the actions of obtaining a first network address of a first device coupled to a network; obtaining first route information associated with at least one data transmission over the network between a first source network address and the first network address, wherein the first route information includes at least a portion of a first sequence of network nodes on a path between the first source network address and the first network address; obtaining a second network address associated with a second device, wherein the first and the second network addresses are different; obtaining second route information associated with at least one data transmission between a second source network address and the second network address, wherein the second route information includes at least a portion of a second sequence of network nodes on a path between the second source network address and the second network address and wherein the first and second sequence of network nodes have a common network node in common; obtaining an estimate for geographical location of the second device; determining a first latency distance between the first network address and the second network address based on the first and second route information; and estimating a geographical location of the first device based on the estimate for geographical location of the second device and the first latency distance between the first network address and the second network address. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The method further includes: obtaining a first group of n events indicative of a geographical location associated with the first device, wherein n is a natural number; and determining that n is less than a predetermined threshold for the number of events; wherein a second group of m events indicative of a geographical location is associated with the second device, wherein m is a natural number and m is greater the predetermined threshold for the number of events, and wherein the estimate for geographical location of the second device has been determined based on the second group of events indicative of a geographical location. The first and second groups of events include one or more queries issued by the first and second devices, respectively, or wherein the first and second group of events include information associated to one or more web-pages accessed by the first and second devices, respectively, or wherein the first and second groups of events include one or more map requests issued by the first and second devices, respectively. The method further includes: obtaining a third network address associated with a third device, wherein the first network address and the third network address belong to a first network address block; and estimating a geographical location of the first network address block based on the estimate for geographical location of the second device and the first latency distance between the first network address and the second network address.

The method further includes: obtaining third route information associated with at least one data transmission between a third source network address and the third network address; determining a second latency distance between the third network address and the second network address based on the second and third route information; and estimating a geographical location of the first network address block based on the estimate for geographical location of the second device and the first and second latency distances between the first and third network address and the second network address. The second network address belongs to a second network address block; and wherein the method further includes: obtaining an estimate for a first number of users associated with the first network address block; and determining that the first number of user is below a predetermined threshold for the number of users; wherein a second number of users is associated with the second device and wherein the second number of users is above the predetermined threshold for the number of users. The geographical location is one of two or more geographical locations, and estimating the geographical location includes determining a probability distribution, wherein the probability distribution includes, for each of the two or more geographical locations, a probability value that the first device is located at the geographical location. The route information further includes propagation times between the network nodes in the first and second sequences of network nodes. The first or second route information includes information related to autonomous network systems that the first or second sequence of network nodes, respectively, are associated with. The common network node is one of a last five network nodes in the first and second sequences of network nodes. The first latency distance is based on a sum of latency distances between (i) the common network node and the first network address and (ii) the common network node and the second network address.

The method further includes: selecting one or more further network addresses associated with one or more further devices, wherein each of the one or more further network addresses is associated with route information including at least a portion of a sequences of network nodes on a path between a source network address and the respective further network address, wherein each sequence of network nodes of the further network addresses has at least one network node in common with the first sequence of network nodes; calculating, for each network address other than the first network address, a respective latency distance between the first network address and the respective other network addresses; obtaining, for each network address other than the first network address, estimates for geographical location of the further devices associated with the one or more further network addresses; and estimating the geographical location of the first device based on the latency distances between the first network address and the further network addresses, the first latency distance between the first network address and the second network address and the estimates for geographical location of the second device associated with the second network address and the further devices associated with the further network addresses.

Estimating the geographical location of the first device includes calculating a weighted sum of terms including one term for the second network address and one term for each of the further network addresses, wherein each term is constructed based on the respective latency distances between the first network address and the second or further network addresses and the respective estimate for geographical location of the second and further devices. The terms include a weight factor depending on a number of users associated with the respective other network address or a number of events associated with the respective other network addresses. The each term includes a functional expression exponentially decreasing with increasing latency distance between the first network address and the respective other network address. Each of the second and one or more further network addresses belongs to a corresponding network address block, and wherein each network address block is distinct from the others. The second and one or more further network addresses are selected based on a confidence measure associated with the estimates for geographical location of the respective second and further devices associated with the second and further network addresses. The confidence measure is based on number of users associated with the respective network addresses or a number of events associated with the respective network addresses. The first and second devices are user devices.

The subject matter described in this specification can be implemented in particular embodiments so as to realize one or more of the following advantages. Geographical locations of devices can be estimated from geographical locations determined for other devices. For example, a geographical location of a single user device or an aggregated group of user devices can be determined based on a geographical location of a nearby device whose geographical location has been determined with a higher degree of certainty.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic drawing of an example topology of a network in which the methods for geographical location of devices described in this specification can be carried out.

FIG. 2 is a flowchart of an example method to estimate a geographical location of a device.

FIG. 3 illustrates an example scenario in which multiple reference groups of devices are used for estimating the geographical location of a first group of devices.

Like reference numbers and designations in the various drawings indicate like elements.

### DETAILED DESCRIPTION

The specification describes technologies using network route information for estimating the geographical location of a network device or a group of network devices, e.g., devices having addresses in a single block of Internet Protocol (IP) addresses (a single “IP address block”). The techniques can be implemented for any kinds of network devices, but user devices are of particular interest. User devices, for example, desktop computers, laptop computers, personal digital assistants, tablet computers, and smartphones, are used to access resources stored on host computer systems, for example, data servers.

### Using Route Information to Estimate Network Device or Device Group Geographical Location

FIG. 1 is a schematic drawing of an example topology of a network in which the methods for estimating the geographical location of devices described in this specification can be carried out. Network devices have network addresses. For instance, the network can be the Internet on which the network devices have an IP address, for instance an IPv4 addresses or an IPv6 addresses.

In this example, the geographical location of a device 20 has been determined with a level of confidence exceeding a predetermined confidence threshold. For example, General

Positioning System (GPS) data has been obtained from the device 20 so that its position is known with at least a threshold degree of certainty. The determination of the location of the device 20 can be determined using the queries issued from that device. Thus, the device 20 will be referred to as a reference device. Similarly, a group of devices may be referred to as a reference group of devices.

Reference devices or reference groups of devices can be selected because their geographical location is known with a level of confidence exceeding a predetermined confidence threshold. In addition, the reference device or group of devices can be selected for likely being close to a first device or first group of devices whose geographical position is to be determined. This can include selecting a reference device or a reference group of devices having network addresses that are expected to be assigned in a spatial proximity of the network address or the network addresses of the first device or first group of devices. In addition or alternatively, the location of common network nodes in a path from a source network address to the first network address and a path from a source network address to the reference network address, respectively, can also be used as a criterion to select a device or group of devices as a reference device or a reference group of devices. In some situations, geographical proximity of the first device or group of devices and the reference device or group can be inferred by the system from the existence of common network nodes in respective paths in the close proximity to the respective devices, e.g., one hop, two hops or up to five hops away.

Route information is obtained for nodes, e.g., routers, 30a-30g located on paths between the source network address, e.g., a network address associated with a host computer system 40, and both a first device 10 and the reference device 20. The location of system 40 may be known. In the example of FIG. 1, both first (solid lines) and reference or second (dashed lines) paths to the respective devices originate from the same source network address. However, it is possible that the first and second paths originate from different network addresses. In the example of FIG. 1, the path between the source network address and the first network address, associated with the first device 10, has six hops and the path between the source network address and the reference network address, associated with the reference device 20, has seven hops. The network addresses of the nodes 30a-30g on the paths between the source network address and the first and the reference network addresses are obtained. The route information includes a respective latency for each of the hops. In the example of FIG. 1, the route information is obtained at a computer system 40 associated with the source network address. However, this information can also be obtained at any other computer system remote from the computer system associated with the source network address. The path information can be obtained using a traceroute utility that determines routes and transit delays of packets across a network, in particular, an IP network. Traceroute data can be obtained starting at multiple source network addresses, including addresses on different continents. Traceroute data can be accumulated over time, and the latencies and/or distances of previous paths found by traceroute can be stored in a historical traceroute database.

An estimate for geographical location of the reference device 20 is obtained at the host computer system. This estimate can have been calculated at the host computer system 40 or at some other computer systems coupled to the host computer system. For example, the estimate for geographical location of the reference device 20 can be obtained from a geographical location database coupled to the host computer system 40. The estimate can have been calculated or determined by any known geographical location method. The estimate for geographical location of the reference device 20 can be obtained at the host computer system 40 when it is required in order to estimate the geographical location of the first client device, or to improve an estimate of the geographical location of the first client device.

In the example of FIG. 1, the first and second paths include four common network nodes before splitting up for the respective last hops ending at the first device 10 and the reference device 20, respectively. However, the first and second paths need to have only one network node in common. Preferably, the reference device is selected so that the common network node is located in a portion of the path proximate to the devices. The common network node can be located in the last half, or the last quarter of a path between the source network address and the destination network address, measured in terms of the total latency of the routes. The common network node can be located among the last five, or the last three network nodes in the sequence of network nodes on the path before the first and the reference network addresses are reached. Selecting reference devices for which common network nodes close to the first and the reference network addresses exist in the respective paths, and using such common network nodes, can enhance the precision of the geographical location estimate of the first device, compared to the case where more remote common network nodes are used. In some cases there is more than one common network node in the paths between a source network address and a first and reference network addresses, respectively. In such situations the closest common network node to the first and reference network addresses can be selected to determine a latency distance between the first and the reference network addresses.

Latency between the first network address and the reference network address can be determined based on the first and second route information. In the example of FIG. 1, the route information includes a respective latency L1-L13 for each hop. The latency between the first and reference network addresses can thus be determined as a sum of the latency between a common network node and the first network address and the latency between a common network node and the reference network address. In the example of FIG. 1, a latency distance between the first and the reference network addresses can be calculated by summing the latency distance between the last common network node and the first network address and the last common network node and the reference network address, i.e., by summing the latencies L12 and L13.

Thus, a geographical location of the first device 10 can be estimated based on the estimate for geographical location of the reference device 20 and the latency distance between the first network address and the reference network address.

The average velocity with which a signal propagates can be used to derive actual geographical distances from observed latencies. This average velocity can be derived empirically for different geographical areas, such as countries or regions. The derived average velocities can be stored in an average velocity database. In the case where a distance between a source network address and a target network address is large, a path may include multiple countries and/or regions. In this situation, multiple average velocities can be used, or an average velocity of the multiple average velocities. As appropriate for the context, a latency distance can be measured in time or, using velocity information, in space.

FIG. 2 is a flowchart of an example method to estimate a geographical location of a device. The method will be described as being performed by a system made up of one or more computers operating in one or more locations.

The system obtains (101) a first network address associated with a first device and first route information that includes at least a portion of a first sequence of network nodes on a path between a first source network address and the first network address; obtains (102) a second network address associated with a second device with a known estimate for a geographical location, wherein the first and the second network addresses are different; obtains (103) second route information that includes at least a portion of a second sequence of network nodes on a path between a second source network address and the second network address, wherein the first and second sequence of network nodes have at least one network node in common, and wherein the first and second source addresses may be the same or different; obtains (104) the known estimate for geographical location of the second device; determines (105) a latency distance between the first network address and the second network address based on the first and second route information; and estimates (106) a geographical location of the first device based on the estimate for geographical location of the second device and the latency distance between the first network address and the second network address.

Using More than One Reference Device or More than One Reference Group of Devices

Moreover, the methods described above to estimate the geographical location of a first device or group of devices can also be extended to take into account more than just one second device or group of devices. By using more than one device or one groups of devices with known geographical position, the quality of the estimate of the geographical location of the first device may be enhanced.

FIG. 3 illustrates an example scenario in which multiple reference groups of devices are used for estimating the geographical location of a first group of devices. In this example, the network is the Internet and the network addresses are IP addresses; however, the methods described in this specification can also be employed in other computer networks. In FIG. 3, the first device 10 has been assigned an IP address of a first IP address block 10a. In addition, five further IP address blocks 20a to 20e are employed as reference groups. As already discussed, the methods described in this specification can also be implemented with fewer or more reference IP address blocks, for example, with a single reference IP address block. In the example of FIG. 3, all paths from a source network address, assigned to a host computer system 40, to the respective IP address blocks have a network node 30a-30c in common with the path from the source network address to the first network address, which is in the first IP address block 10a. The common node can be a different node for every reference IP address block or for some IP address blocks, as depicted in FIG. 3, or all reference IP address blocks can share the same common network node. The geographical locations of the devices associated with the five reference IP address blocks 20a-20e are obtained. As in the preceding examples, these geographical locations are known with a degree of certainty higher than a threshold value. For each of the five additional IP address blocks 20a to 20e, a latency is calculated between the respective IP addresses of the IP address block and the first IP address block 10a including the first IP address associated with the first device 10. Then, all these latencies and all these estimates can be used to estimate the geographical location of the first group of devices associated with the first IP address block 10a.

The degree of certainty of an estimate for a geographical location of a reference device or a group of devices can be estimated based on different factors. In one example, as described above, the estimate for a geographical location can be based having geographical position data from a trustworthy source. If, for instance, recent GPS data are obtained the reference device or reference group of devices their geographical location can be determined with a predetermined level of confidence. Other possibilities to obtain geographical position data include using other signals that explicitly and reliably encode a geographical position of the reference device or the reference group of devices.

Estimating the geographical location of the reference device or group of devices can be performed as part of the methods described in this specification. Alternatively, the estimates can be pre-computed and stored in a geographical location database from which the estimates can be obtained when required.

In other examples, the second and further network nodes are network nodes, e.g., routers, whose geographical location is known. In such cases, the latency between the first network address and the second and further network addresses can be used to estimate the geographical location of the first device or group of devices employing a triangulation process. This can involve determining a geographical distance from the determined latencies as described above. In a next step, the estimated geographical location of the first device or group of devices can be determined as a geographical location where circles with a radius corresponding to these geographical distances touch. In many situations, the estimated geographical distance corresponding to the obtained latencies might differ from an actual geographical distance between a router with a known geographical location and the first device or the group of devices. In such cases, there might not be a touching point of the multiple circles around the routers having a known geographical location. In such cases, the geographical location can be estimated as a geographical location consistent with the geographical distances corresponding to the obtained latencies. For example, a sum of distances to the circles can be minimized.

The methods described in this specification can also be employed if the estimates of geographical location are probability distributions. Each probability distribution indicates a probability, for each of a set of geographical locations, of finding the corresponding device or group of devices at that location. In the case of a group of devices, such as the devices an IP address block is associated with, an estimate of the fraction of a group of devices located at each geographical location can be derived from the probability distributions.

In some implementations, the estimate for the geographical location of a first group of devices is calculated as a weighted sum of the probability distributions of the geographical locations of multiple reference devices or reference groups of devices. The latencies can be used to weight the contributions of the different reference devices or reference groups of devices. In one example, the weight factor increases with decreasing latency between a reference device or reference group of devices and the first network address or group of network addresses. In this manner, reference devices or reference groups of devices with low latency, which are likely located close to the first device or the first group of devices, have larger influence on the estimate for geographical location of the first device or group of devices than other reference devices or reference groups of devices with higher latency, which are likely located further away from the first device or the first group of devices. The weight factor can depend linearly on the latencies. Alternatively, the weight factor can depend exponentially on the latencies, e.g., decrease exponentially with increasing latency.

In some implementations of the methods described in this specification, the geographical location of the reference device or the reference group of devices are estimated, at least partially, based on events obtained from the reference device or the reference group of devices, such as search queries. In this situation, the estimate for the geographical location of the reference device or the reference group of devices can be more trustworthy than an estimate for the geographical location of the first device or first group of devices. The trustworthiness of an estimate for a geographical location determined based on events can be influenced by different factors. An estimate based on a low number of events, e.g., fewer than 10 or 100 or 1,000, might be considered less trustworthy than an estimate based on a large number of events, e.g., more than 100 or 1,000 or 10,000. An estimate for geographical location of a single device or a small group of devices, e.g., less than 5 or 20 or 50 devices, might not be considered as trustworthy as an estimate for a larger group of devices.

### Checking for Consistency

A geographical location estimated for a first device or a first group of devices can be checked for consistency after it has been determined. For example, the estimated geographical location can be compared with a prior determined geographical location for similar route information and/or latencies. If the distance between the geographical location of the source address and the estimated geographical location of the first address or the first group of addresses differs by more than a threshold amount from previously determined distances for paths with similar latency, an estimate for geographical location can be flagged as potentially not trustworthy. In a case where an estimate for geographical location is flagged as potentially not trustworthy, the methods described in this specification can be repeated, e.g., with a different set of reference devices or reference groups of devices. The threshold amount can be a distance 50% or 25% of a previously determined distance.

Instead of repeating the geographical location estimation, the estimated geographical location can be adjusted to be consistent with the multiple paths obtained.

The known geographical locations of network nodes can be stored in a network node location database. This database can be continuously revised and updated.

For the geographical locations of routers, other information can be used to check the consistency of an estimate of the locations. For example, routers have often names including a country code or a suffix including information regarding the routers' locations. In some cases, this information can be used to improve the quality of the estimates for geographical location. This information can be used for network addresses located near a border to resolve ambiguities. For example, if a network node has a name including the country code “.mx” and it was determined that this node is located in San Diego with 50% probability and in Tijuana with 50% probability, a system can use the country code in the name of the network node to increase the probability that the network node is located in Tijuana by a factor, for example, to as much as 100%.

Generating Geographical Location Estimates from Events

An estimate for the probability distribution of the geographical locations of a device or the group of devices on a network can be obtained by a classifier that uses Bayesian models, and, in particular, that uses the methods and models described in U.S. patent application Ser. No. 13/830,182 for “Determining Geo-Locations of Users From User Activities” filed on Mar. 14, 2013, the content of which is incorporated here by reference in its entirety. As described there, such a classifier can estimate the geographical location of a device or a group of devices from events obtained from the device or the group of devices, e.g., the devices associated with an IP address block. The estimate can be represented as a probability distribution of geographical locations X for a device or a group of devices. The probability distribution X contains, for each geographical location in a set of geographical locations, a probability that a device or a group of devices, e.g., an IP address block, is located at the respective geographical location. The set of geographical locations can be predetermined or it can be derived from events received from the devices.

### Using Route Information in Bayesian Models

As described above, route information can be obtained for an IP address associated with a device or group of devices whose geographical location is to be determined. Elements of the route information can be used as events in a Bayesian model, e.g., to determine for each of a set of locations a probability in the model that the event was obtained from or relates to a device at the location.

One kind of route information that can be used in this way is latency distances from routers having known locations, i.e., locations known to a certainty above a predetermined threshold value. Other route information can also be used. For example, the autonomous system number (ASN) of an IP address has predictive power for its geographical location. Therefore, if it has been determined that an IP address has a certain ASN, that can be used as an additional event. Probabilities can be derived that this ASN is observed given that a device or group of devices is located at each of a set of geographical locations, and these probabilities can be included in the model.

The knowledge of the ASN of a network address can have comparatively large predictive power regarding its geographical location. An Autonomous System (AS) is a collection of connected Internet Protocol (IP) routing prefixes under the control of one or more network operators that presents a common, clearly defined routing policy to the Internet. Usually, a network operator, e.g., an Internet service provider, or a company has one or more, usually a limited number, of ASNs. Typically, an ASN is located in a country or a smaller region. Therefore, if the ASN is known, a geographical location estimate can be determined or improved. Thus, in some implementations, events based on ASNs are given a larger weight than other events, e.g., a search query issued by a device. This can be done, e.g., by adding ASN events multiple times to the set of events. For example, an ASN event can be added once for every other observed event.

Additional sources of route information can be used to improve the geographical location estimates calculated as described above. For example, border gateway protocol (BGP) routers know for each IP network address at least a next hop. They maintain routing tables for keeping and regularly updating this information. The routing tables can be read-out to obtain additional information about routable IP network nodes. In addition, BGP announcements can be tracked to obtain IP reassignments without the need of periodic read-outs of the routing tables.

Alternatively, the Bayesian methods to estimate these geographical locations can also be performed with a set of events exclusively based on the route information described in this specification.

### Using Route Information to Smooth Classifier Output

In some cases, the classifier has little information from which to determine its estimate for the location of a device or group of devices. For example, the number of events or the number of distinct users from which events were obtained or both may be relatively small, below a predetermined threshold value. To obtain a better estimate, the following methods can be used. These will be described, for the sake of example, as performed by a system of one or more computers using data representing IP address blocks.

The get a better estimate for a first IP address block x for which the classifier has a small amount of evidence, e.g., a small amount of event or user data, the system uses network route information to find other IP address blocks yᵢ that are likely to be close to block x, and use the classifier estimates for the blocks yᵢ as additional information. This can be done for multiple IP blocks x.

In particular, for each IP block x, determine the set of other IP blocks {y₁, y₂, . . . , yₖ} with the following property: in a path to yᵢ there is a router rᵢ in the sequence of routers that is among the last three routers that also appear in the sequence of routers in a path to x. If there is more than one such router, the one closest to yᵢ and x is selected as rᵢ.

Then, determine a latency distance dᵢ between x and yᵢ as the sum of the latency distance between x and rᵢ and the latency distance between rᵢ and yᵢ.

Then, for all the yᵢ, sum up the location distributions X given by the classifier for yᵢ, weighting them in the summation with a weight that is a product of a term representing the amount of evidence the classifier has for the location of yᵢ times a function of the latency distance dᵢ.

For instance, in a case with n reference groups of devices, where Nᵢ is the number of events obtained from the i-th reference group of devices, a probability value Pₑₛₜ that the first group of devices is located at geographical location Lⱼ can be determined as:

$${P}_{est} ( {L}_{j} ) = {\sum }_{i = 1}^{n} {N}_{i} {P}_{i} ( {L}_{j} ) f ( {d}_{i} ) ,$$

where f represents a predetermined function, dᵢ represents the latency between the common network node of the path of the first device or group of devices and the i-th reference device or reference group of devices, and Nᵢ is the amount of evidence for the probability estimate Pᵢ for the i-th reference device or reference group of devices, e.g., for yᵢ. In some implementations, the predetermined function is f(dᵢ)=exp(−dᵢ/c), with a preselected constant c. This process can be repeated for every location Lⱼ to determine the probability values constituting the probability distribution of geographical locations of the first group of devices. Optionally, the probability values can be normalized to ensure that the probability values sum to 1. This can also be ensured by properly selecting the constant c.

In some implementations, the probability distribution of geographical locations can be reduced to a point, i.e., a single geographical location representing the geographical location of the first device or group of devices, e.g., the IP address block x. One method to do so is to calculate a center of gravity of the probability distribution. This can include assigning a geographical coordinate value to each of the locations over which the probability distribution is defined. In a next step, the coordinates can be summed with their respective probabilities as weights to obtain the coordinates of the center of gravity of the probability distribution.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining a first network address of a first device coupled to a network;
obtaining first route information associated with at least one data transmission over the network between a first source network address and the first network address, wherein the first route information includes at least a portion of a first sequence of network nodes on a path between the first source network address and the first network address;
obtaining a second network address associated with a second device, wherein the first and the second network addresses are different;
obtaining second route information associated with at least one data transmission between a second source network address and the second network address, wherein the second route information includes at least a portion of a second sequence of network nodes on a path between the second source network address and the second network address and wherein the first and second sequence of network nodes have a common network node in common;
obtaining an estimate for geographical location of the second device;
determining a first latency distance between the first network address and the second network address based on the first and second route information; and
estimating a geographical location of the first device based on the estimate for geographical location of the second device and the first latency distance between the first network address and the second network address.

2. The method of claim 1, further comprising:
obtaining a first group of n events indicative of a geographical location associated with the first device, wherein n is a natural number; and
determining that n is less than a predetermined threshold for the number of events;
wherein a second group of m events indicative of a geographical location is associated with the second device, wherein m is a natural number and m is greater the predetermined threshold for the number of events, and wherein the estimate for geographical location of the second device has been determined based on the second group of events indicative of a geographical location.

3. The method of claim 2, wherein the first and second groups of events include one or more queries issued by the first and second devices, respectively, or wherein the first and second group of events include information associated to one or more web-pages accessed by the first and second devices, respectively, or wherein the first and second groups of events include one or more map requests issued by the first and second devices, respectively.

4. The method of claim 1, further comprising:
obtaining a third network address associated with a third device, wherein the first network address and the third network address belong to a first network address block; and
estimating a geographical location of the first network address block based on the estimate for geographical location of the second device and the first latency distance between the first network address and the second network address.

5. The method of claim 4, further comprising:
obtaining third route information associated with at least one data transmission between a third source network address and the third network address;
determining a second latency distance between the third network address and the second network address based on the second and third route information; and
estimating a geographical location of the first network address block based on the estimate for geographical location of the second device and the first and second latency distances between the first and third network address and the second network address.

6. The method of claim 4, wherein the second network address belongs to a second network address block; and wherein the method further comprises:
obtaining an estimate for a first number of users associated with the first network address block; and
determining that the first number of user is below a predetermined threshold for the number of users;
wherein a second number of users is associated with the second device and wherein the second number of users is above the predetermined threshold for the number of users.

7. The method of claim 1, wherein:
the geographical location is one of two or more geographical locations, and
estimating the geographical location includes determining a probability distribution, wherein the probability distribution includes, for each of the two or more geographical locations, a probability value that the first device is located at the geographical location.

8. The method of claim 1, wherein the route information further comprises propagation times between the network nodes in the first and second sequences of network nodes.

9. The method of claim 1, wherein the first or second route information includes information related to autonomous network systems that the first or second sequence of network nodes, respectively, are associated with.

10. The method of claim 1, wherein the common network node is one of a last five network nodes in the first and second sequences of network nodes.

11. The method of claim 1, wherein the first latency distance is based on a sum of latency distances between (i) the common network node and the first network address and (ii) the common network node and the second network address.

12. The method of claim 1, further comprising:
selecting one or more further network addresses associated with one or more further devices, wherein each of the one or more further network addresses is associated with route information including at least a portion of a sequences of network nodes on a path between a source network address and the respective further network address, wherein each sequence of network nodes of the further network addresses has at least one network node in common with the first sequence of network nodes;
calculating, for each network address other than the first network address, a respective latency distance between the first network address and the respective other network addresses;
obtaining, for each network address other than the first network address, estimates for geographical location of the further devices associated with the one or more further network addresses; and
estimating the geographical location of the first device based on the latency distances between the first network address and the further network addresses, the first latency distance between the first network address and the second network address and the estimates for geographical location of the second device associated with the second network address and the further devices associated with the further network addresses.

13. The method of claim 12, wherein estimating the geographical location of the first device includes calculating a weighted sum of terms including one term for the second network address and one term for each of the further network addresses, wherein each term is constructed based on the respective latency distances between the first network address and the second or further network addresses and the respective estimate for geographical location of the second and further devices.

14. The method of claim 13, wherein the terms include a weight factor depending on a number of users associated with the respective other network address or a number of events associated with the respective other network addresses.

15. The method of claim 13, wherein the each term includes a functional expression exponentially decreasing with increasing latency distance between the first network address and the respective other network address.

16. The method of claim 12, wherein each of the second and one or more further network addresses belongs to a corresponding network address block, and wherein each network address block is distinct from the others.

17. The method of claim 12, wherein the second and one or more further network addresses are selected based on a confidence measure associated with the estimates for geographical location of the respective second and further devices associated with the second and further network addresses.

18. The method of claim 17, wherein the confidence measure is based on number of users associated with the respective network addresses or a number of events associated with the respective network addresses.

19. The method of claim 1, wherein the first and second devices are user devices.

20. A computer system including:
a route information database configured to store route information associated with at least one data transmission between a source network address and a target network address, wherein the route information includes at least a portion of a sequence of network nodes on a path between the source network address and the target network address;
a latency distance determination module configured to determine a latency distance between network addresses by using route information;
one or more computers configured to:
obtain a first network address associated with a first device;
obtain, from the route information database, first route information associated with at least one data transmission from a first source network address and the first network address, wherein the first route information includes at least a portion of a first sequence of network nodes on a path between the first source network address and the first network address;
obtain a second network address associated with a second device, wherein the first and the second network addresses are different;
obtain second route information associated with at least one data transmission between a second source network address and the second network address, wherein the second route information includes at least a portion of a second sequence of network nodes on a path between the second source network address and the second network address and wherein the first and second sequence of network nodes have at least one network node in common;
obtain an estimate for geographical location of the second device;
determine a first latency distance between the first network address and the second network address based on the first and second route information; and
estimate a geographical location of the first device based on the estimate for geographical location of the second device and the first latency distance between the first network address and the second network address.

21. The system of claim 20, wherein the route information database further is configured to store propagation times between the network nodes in the sequence of network nodes.

22. The system of claim 20, further comprising:
an event database configured to store events indicative of a geographical location associated with the first and second devices;
wherein the one or more computers are further configured to:
obtain a first group of n events indicative of a geographical location associated with the first device from the event database, wherein n is a natural number; and
determine that n is below a predetermined threshold for the number of events; and
wherein a second group of m events indicative of a geographical location is associated with the second device, wherein m is a natural number, wherein m is above the predetermined threshold for the number of events and wherein the estimate for geographical location of the second device has been determined based on the second group of events indicative of a geographical location.

23. The system of claim 20, wherein the one or more computers are further configured to:
select one or more further network addresses associated with one or more further devices, wherein each of the one or more further network addresses is associated with route information including at least a portion of sequences of network nodes on a path between a source network address and the respective further network address, wherein each of the sequences of network nodes has at least one network node in common with the first sequence of network nodes;
calculate, for each network address other than the first network address, a respective latency distance between the first network address and the respective other network addresses;
obtain, for each further network address, estimates for geographical location of the further devices associated with the one or more further network addresses; and
estimate the geographical location of the first device based on the latency distances between the first network address and the further network addresses, the first latency distance between the first network address and the second network address and the estimates for geographical location of the second device associated with the second network address and the further devices associated with the further network addresses.

24. A computer readable medium having instructions stored thereon which when executed by a system of one or more computers cause the system to perform operations comprising:
obtaining a first network address of a first device coupled to a network;
obtaining first route information associated with at least one data transmission over the network between a first source network address and the first network address, wherein the first route information includes at least a portion of a first sequence of network nodes on a path between the first source network address and the first network address;
obtaining a second network address associated with a second device, wherein the first and the second network addresses are different;
obtaining second route information associated with at least one data transmission between a second source network address and the second network address, wherein the second route information includes at least a portion of a second sequence of network nodes on a path between the second source network address and the second network address and wherein the first and second sequence of network nodes have at least one network node in common;
obtaining an estimate for geographical location of the second device;
determining a first latency distance between the first network address and the second network address based on the first and second route information; and
estimating a geographical location of the first device based on the estimate for geographical location of the second device and the first latency distance between the first network address and the second network address.
